(19) United States
(12) Patent Application Publication
(10) Pub. No.: US 2003/0217258 A1
(43) Pub. Date: Nov. 20, 2003

(54) Apparatus and method of using ephemeral asymmetric keys to exchange security data between hardware security modules

(75) Inventor: Steven A. Bade, Georgetown, TX (US)

Correspondence Address: Mr. Volel Emile, P.O. Box 202170, Austin, TX, 78720-2170, US

(73) Assignee: International Business Machines Corporation

(21) Appl. No.: 10/150,115

(22) Filed: May 16, 2002

(51) Int. Cl. H04L 9/00

(52) U.S. Cl. 713/150

(57) ABSTRACT

A method, system and apparatus for securely transferring security relevant data items (SRDIs) between two hardware security modules (HSMs) attached to a computer system. When a first HSM needs to transfer SRDIs to a second HSM, it indicates so to the second HSM are provided. The second HSM then generates an ephemeral public key/private key pair and transfer the public key to the first HSM. The first HSM then uses the transferred public key to encrypt the SRDIs before transferring them to the second HSM. When generating the public key/private key pair, the first HSM also starts a timer. The timer is used to ascertain that the ephemeral keys are not used any longer than they should.

### BACKGROUND OF THE INVENTION

1. Technical Field

The present invention is directed to communications networks. More specifically, the present invention is directed to a method and apparatus for secure data transactions between two hardware security modules (HSMs).

2. Description of Related Art

As more and more households are having access to the Internet, more and more business and financial transactions are occurring on-line (i.e., over the Internet). When doing so, sensitive information such as credit card information or financial transaction data etc. often has to be exchanged. The Internet, however, is an open network environment and thus requires a high level of security assurance when completing business or financial transactions. Thus to provide the requisite security assurance, a lot of organizations have resorted to encryption.

To encrypt data is to translate the data into a secret code. To decrypt the data, a secret key or password is used. Specifically, when a client system, being used by a customer, is establishing connection with a server of an organization, it does so by opening a Secure Socket Layer (SSL) connection. SSL is a security protocol that is used to transmit private documents over the Internet. SSL works by using a public key to encrypt data that is being transferred over the connection. Thus, the client system has to first obtain the server's public key. Using the public key, the client encrypts all data that is being transferred to the server. Only the server has the corresponding private key to decrypt the encrypted data.

Likewise, the client may generate its own public key/private key pair and pass the public key to the server. The server may then encrypt all information that is to be transferred to the client using the client's public key. As in the case of the server, only the client has the private key with which the encrypted data may be decrypted.

Servers' private keys are often exposed in the servers' memory systems in clear text. Such exposure undermines the security assurance provided by encrypting data as the server's private key is quite vulnerable to cyber-thefts. Consequently, organizations have been using Hardware Security Modules (HSMs) to safeguard their encryption keys.

An HSM is a tamper-resistant adapter or a piece of hardware that provides secure key generation, secure key storage and secure key archival. If an HSM is ever tampered with, all information is zeroed out. A co-processor inside the HSMs handles generation of public and private key pair, encryption as well as decryption of sensitive information.

Some servers may contain more than one HSM. Each HSM has a finite number of SSL connections that it can support. There may be times when the capacity for handling more than that finite number may be needed. When this occurs, security relevant data items (SRDI) such as private keys, master keys etc. of a first HSM may have to be securely transferred to a second HSM in order to enhance the capability of the first HSM. Doing so may allow clients to continue to use the same SRDIs originally transferred to them, while transacting data with the second HSM.

Thus, what is needed is an apparatus, system and method of securely exchanging SRDIs between two or more HSMs.

### SUMMARY OF THE INVENTION

The present invention provides a method, system and apparatus for securely transferring security relevant data items (SRDIs) between two hardware security modules (HSMs) attached to a computer system. When a first HSM needs to transfer SRDIs to a second HSM, it indicates so to the second HSM. The second HSM then generates an ephemeral public key/private key pair and transfer the public key to the first HSM. The first HSM then uses the transferred public key to encrypt the SRDIs before transferring them to the second HSM. When generating the public key/private key pair, the first HSM also starts a timer. The timer is used to ascertain that the ephemeral keys are not used any longer than they should.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 illustrates a cryptographic scheme that does not involve an HSM.

FIG. 5 illustrates an HSM-based cryptographic scheme.

FIG. 6 is a flow chart of a process that may be used with the invention.

### DETAILED DESCRIPTION OF THE PREFERRED EMBODIMENT

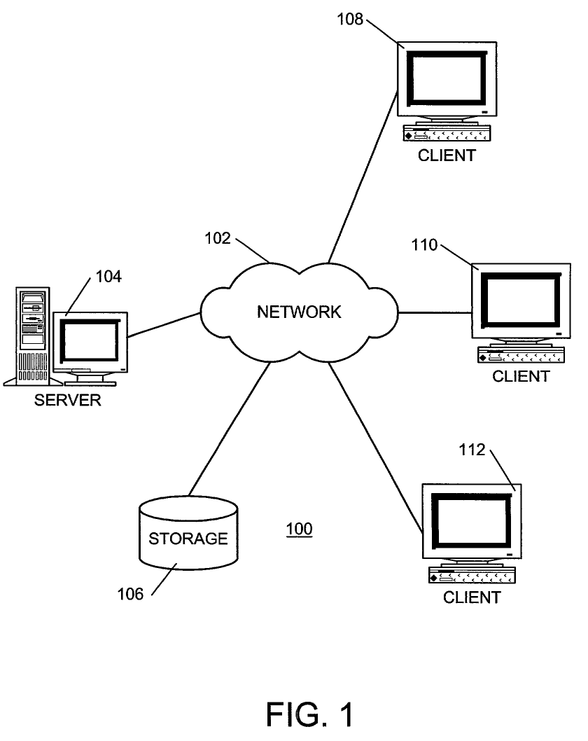

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

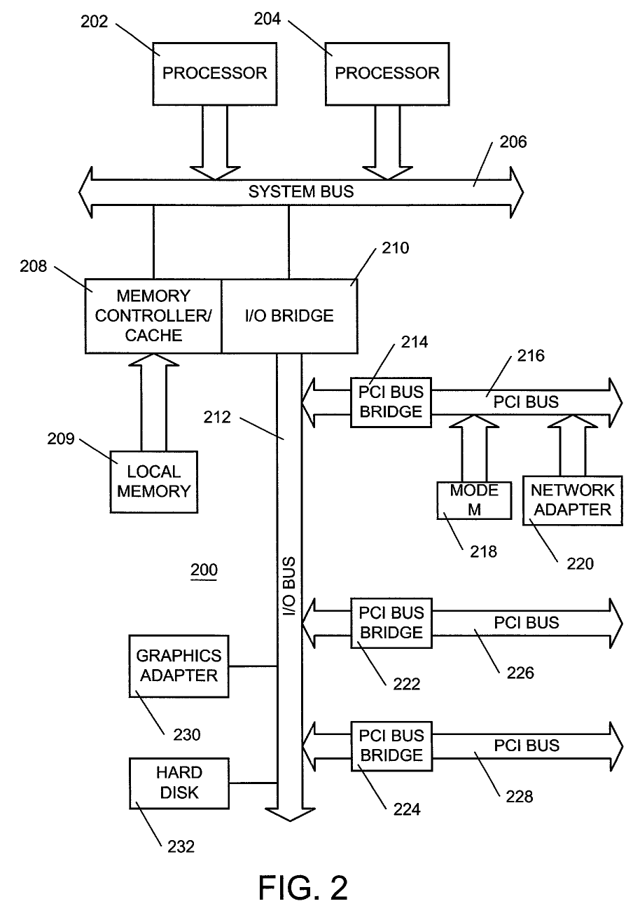

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

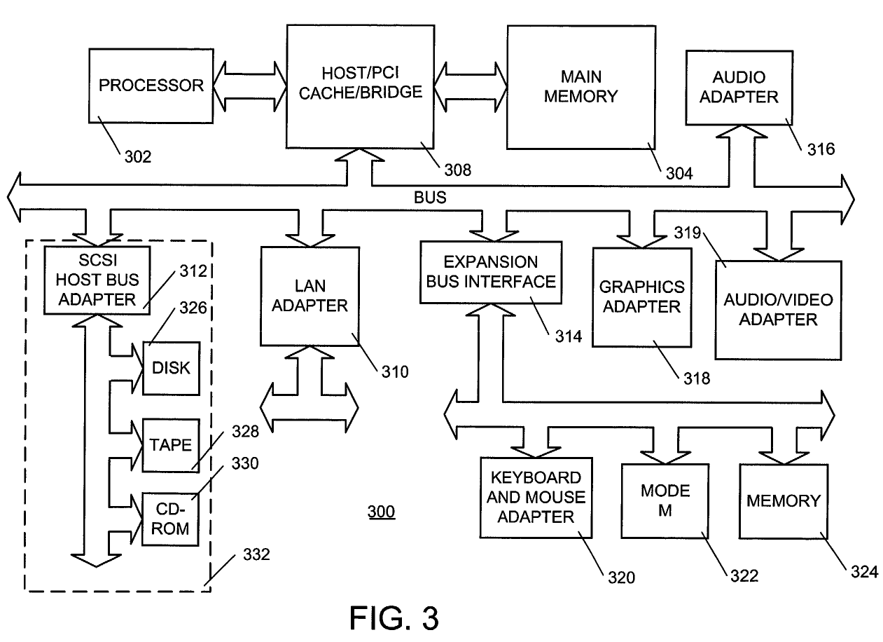

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus, system and method of exchanging security relevant data items (SRDIs) between two or more HSMs attached to the same computer system. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

As alluded to before, Secure Socket Layer (SSL) is an upper-layer protocol commonly used by Web browser clients and servers to provide peer authentication and encryption of application data. SSL mandates that the server authenticate itself to the client via a certificate-based technique. SSL involves a handshake phase, where certificates are exchanged, session keys are generated, and encryption algorithms are agreed upon. After the handshake phase, user data is exchanged securely without the need for the application to be explicitly modified, other than to invoke the SSL services before actual data transfer begins. SSL is an end-to-end protocol, and therefore will be implemented in the machines at the end points of a given path (typically the client and the server), but it is not implemented in intermediate machines (such as in routers or firewalls) along a given path.

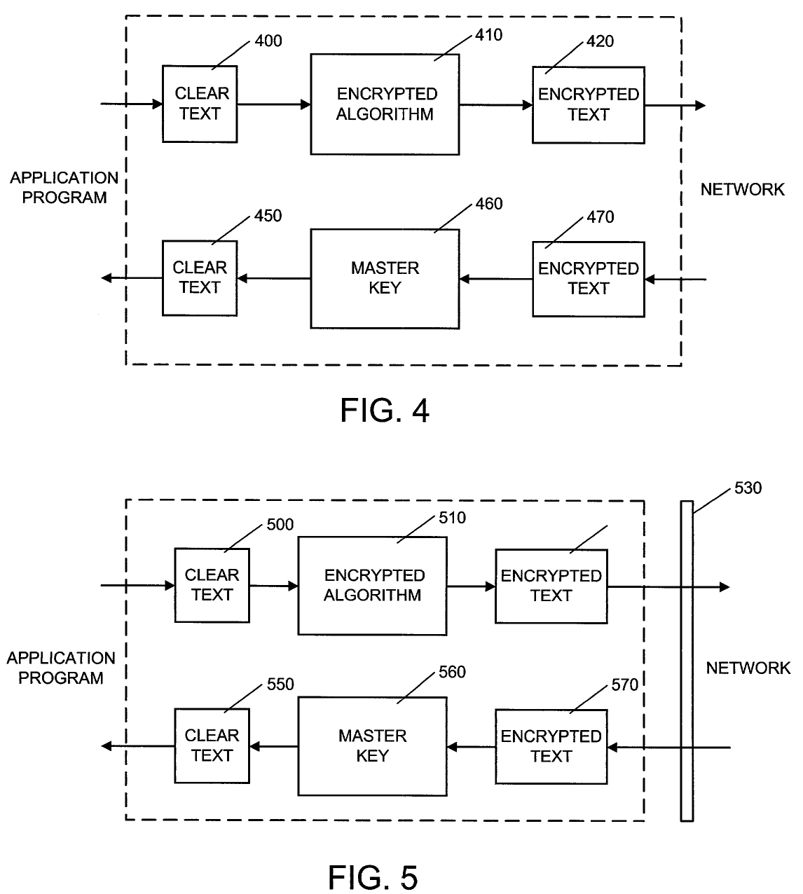

FIG. 4 illustrates a cryptographic scheme that does not involve an HSM. As stated above, when data is to be transacted securely, the transacting systems have to go through a handshake phase. In that phase, public keys are exchanged (i.e., system₁ will send its public key to system₂ and system₂ will send its public key to system₁). The public keys are used to encrypt data that is to be sent from one system to another. For example in FIG. 4, if clear text 400 is to be encrypted before entering the network, the public key is used to encrypt the clear text data when it passes through crypto algorithm 410. The resulting encrypted text 420 is allowed to enter the network. Encrypted text 470 received from the network is passed through a box 460 that contains the system's master key and the resulting decrypted text 450 is sent to the application program.

Almost all currently popular security protocols begin by using public key cryptography to support a handshake that generates one or more master secrets. The master secrets are then used to generate the algorithm-specific keys needed by the authentication and encryption algorithms to protect user-data. Since an authenticated exchange of master key information is the base on which all further security protocols depend, there is a need for supplementary protocols and procedures to issue, distribute, and verify the certificates that will bind each user to its public key.

In FIG. 4, all the cryptographic components (i.e., crypto algorithm, master key, clear text, decrypted text etc.) reside in unprotected memory where they are susceptible to duplication, modification or substitution. Note that in this case the most susceptible element is the master key. A duplicated master key allows a non-authorized person to decrypt encrypted data.

FIG. 5 illustrates an HSM-based cryptographic scheme. As in FIG. 4, when clear text 500 is to be encrypted before entering the network, the public key received by the system is used to encrypt the clear text data when it passes through crypto algorithm 510. Only then is the text allowed to enter the network. Encrypted text 570 received from the network is passed through box 560 that contains the system's master key and the resulting decrypted text 550 is sent to the application program. Here however, there is a physical as well as a logical barrier 530 where data is allowed to pass while algorithm and key are kept secure in protected memory of a tamper-resistant security device, the HSM.

The HSM may be a hardware adapter card attached to a computer system through a PCI slot or a standalone hardware that connected to the system through universal serial bus (USB) port or an RS-232 port. As mentioned before, some computer systems may have more than one HSM. When an application program is using the maximum number of sessions that a first HSM can handle and if the computer system has an idle HSM and the application wants to open more sessions, it would be desirable to use the idle HSM as an extension of the first HSM. In this case, the idle HSM will use the same master key etc. as the first HSM. Therefore, the first HSM has to transmit its security relevant data items (SRDIs) to the idle HSM. However, since the SRDIs will be transferred over the PCI bus, which is not a protected bus (i.e., data on this bus may be monitored and captured by unauthorized personnel), the SRDIs have to be transferred securely. The present invention ensures that the SRDIs are so transferred.

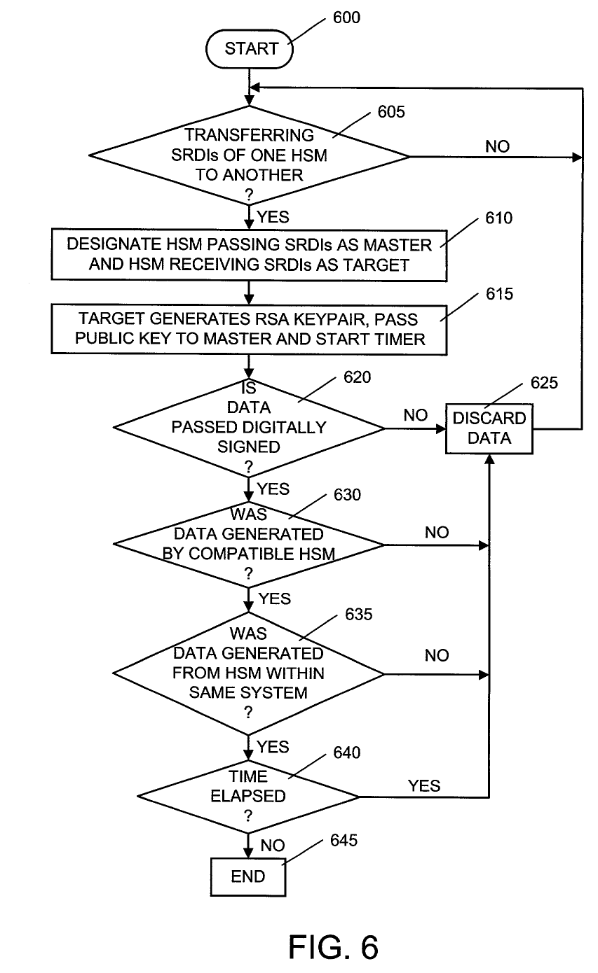

FIG. 6 is a flow chart of a process that may be used with the invention. The process starts when the system is turned on or is reset (step 600). Then a check is continuously being made to determine whether SRDIs of a first HSM need to be transferred to a second HSM. This usually occurs when there are more SSL connections than the first HSM can support. If the SRDIs of the first HSM need to be transferred to the second HSM, the first HSM is designated as master HSM and the second HSM is designated as target HSM. Note that the target HSM is preferably an idle HSM. The target HSM then generates an ephemeral (i.e. short-lived, one time use) RSA key pair, exports the public portion of the key to the master HSM and starts a timer. The exportation of the public portion of the key must be digitally signed by the target HSM to ensure integrity. The timer is used to prevent replay attacks as well as to ensure that the key pair is invalidated quickly as a further security measure. The master HSM imports the public portion of the key and verifies its integrity through the digital signature. This then validates that the key was generated by a compatible HSM.

Note that other information may be used in the signature to verify that the key originated from an HSM connected to the same computer system. For example, if the HSMs were part of a group of HSMs with a group name and if the group name was loaded into all the HSMs, the group name may be used to ascertain that the key originated from the an HSM connected to the same computer system.

After ensuring that the key came from an HSM connected to the same computer system, the master HSM may then encrypt the SRDIs with the imported public key and digitally sign the message. The encrypted message may then be sent to the target HSM where it may be decrypted using the private key of the generated key pair. In the event that the target key lifetime timer expires, the imported data may be discarded as no private key will exist to decrypt any message sent by the master HSM. When that occurs, the process may start all over again (steps 605-645).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of securely transacting security relevant data items (SRDIs) between a first and a second device comprising the steps of:
determining by the second device whether the first device needs to transmit SRDIs;
generating by the second device, if the first device needs to transmit SRDIs, an ephemeral cryptographic public key/private key pair;
transferring, by the second device, the ephemeral public key to the first device, the transferred public key for encrypting the SRDIs and the private key for decrypting the encrypted SRDIs;
encrypting the SRDIs by the second device; and
transferring the encrypted SRDIs by the second device to the first device.

2. The method of claim 1 wherein the first and the second devices are hardware security modules (HSMs).

3. The method of claim 2 wherein the HSMs are attached a common computer system.

4. The method of claim 3 wherein a timer with a set time is started when the ephemeral keys are generated.

5. The method of claim 4 wherein the ephemeral keys last as long as the timer.

6. A computer program product on a computer readable medium for securely transacting security relevant data items (SRDIs) between a first and a second device comprising:
code means for determining by the second device whether the first device needs to transmit SRDIs;
code means for generating by the second device, if the first device needs to transmit SRDIs, an ephemeral cryptographic public key/private key pair;
code means for transferring, by the second device, the ephemeral public key to the first device, the transferred public key for encrypting the SRDIs and the private key for decrypting the encrypted SRDIs;
code means for encrypting the SRDIs by the second device; and
code means for transferring the encrypted SRDIs by the second device to the first device.

7. The computer program product of claim 6 wherein the first and the second devices are hardware security modules (HSMs).

8. The computer program product of claim 7 wherein the HSMs are attached a common computer system.

9. The computer program product of claim 8 wherein a timer with a set time is started when the ephemeral keys are generated.

10. The computer program product of claim 9 wherein the ephemeral keys last as long as the timer.

11. An apparatus for securely transacting security relevant data items (SRDIs) comprising:
means for determining by whether a device needs to transmit SRDIs;
means for generating, if the device needs to transmit SRDIs, an ephemeral cryptographic public key/private key pair; and
means for transferring the ephemeral public key to the device, the transferred public key for encrypting the SRDIs by the device and the private key for decrypting the encrypted SRDIs when the encrypted SRDIs are received.

12. The apparatus of claim 11 wherein the SRDIs are encrypted and decrypted by hardware security modules (HSMs).

13. The apparatus of claim 12 wherein the HSMs are attached to a common computer system.

14. The apparatus of claim 13 wherein a timer with a set time is started when the ephemeral keys are generated.

15. The apparatus of claim 14 wherein the ephemeral keys last as long as the timer.

16. A computer system for securely transacting security relevant data items (SRDIs) between a first and a second device comprising:
at least a storage device for storing code data; and
at least a processor for processing the code data to determine whether the first device needs to transmit SRDIs to the second device, to generate, if the first device needs to transmit SRDIs to the second device, an ephemeral cryptographic public key/private key pair, to transfer, the ephemeral public key to the first device, the transferred public key for encrypting the SRDIs and the private key for decrypting the encrypted SRDIs, to encrypt the SRDIs, and to transfer the encrypted SRDIs to the first device.

17. The computer system of claim 16 wherein the first and the second devices are hardware security modules (HSMs).

18. The computer system of claim 17 wherein the HSMs are both attached to the computer system.

19. The computer system of claim 18 wherein a timer with a set time is started when the ephemeral keys are generated.

20. The computer system of claim 19 wherein the ephemeral keys last as long as the timer.
